(19) United States
(12) Patent Application Publication
(10) Pub. No.: US 2026/0082402 A1
(43) Pub. Date: Mar. 19, 2026

(54) SYSTEMS AND METHODS TO DYNAMICALLY RECONFIGURE NETWORK RESOURCES WITHIN TELECOMMUNICATION NETWORKS

(71) Applicant: DISH Wireless L.L.C., Englewood, CO (US)

(72) Inventor: Karupaiah Rajendran, Sachse, TX (US)

(21) Appl. No.: 18/886,635

(22) Filed: Sep. 16, 2024

(51) Int. Cl. H04W 72/27; H04W 24/08; H04W 72/02; H04W 72/52; H04W 76/10

(52) U.S. Cl. CPC H04W 72/27; H04W 24/08; H04W 72/02; H04W 72/52; H04W 76/10

(57) ABSTRACT

Systems and methods to dynamically reconfigure network resources within telecommunication networks. One system may include a processing system configured to maintain a mapping that indicates characteristic(s) associated with each network resource of the telecommunications network. The processing system may be configured to detect that a first distributed unit (DU) of the telecommunications network is being overloaded. The processing system may be configured to determine, using the mapping, a resource availability status for a second DU included in the telecommunications network. The processing system may be configured to reconfigure the second DU to process the portion of the traffic demand of the first DU. The processing system may be configured to control transport of the portion of the traffic demand of the first DU such that the second DU processes the portion of the traffic demand.

### BACKGROUND

Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods to dynamically reconfigure network resources within telecommunication networks to optimize network performance and network resource usage by improving network resource efficiency while also reducing network resource maintenance, costs associated with implementing additional network resources or infrastructure, etc.

According to one aspect of the present disclosure, a system to dynamically reconfigure network resources within telecommunication networks. The system may include a processing system including one or more electronic processors configured to: maintain a mapping for a telecommunications network, wherein the mapping indicates a plurality of characteristics associated with each of a plurality of network resources included in the telecommunications network, the plurality of network resources including a first distributed unit (DU) and a second DU; detect, based on network traffic data for a telecommunications network, that the first DU included in the telecommunications network has a traffic demand that exceeds a threshold; determine, using the mapping, a resource availability status for the second DU included in the telecommunications network; and, when the resource availability status for the second DU indicates that the second DU has available resources to process a portion of the traffic demand of the first DU: reconfigure the second DU such that the second DU is configured to process the portion of the traffic demand of the first DU; and control transport of the portion of the traffic demand of the first DU such that the second DU processes the portion of the traffic demand.

According to another aspect of the present disclosure, a method to dynamically reconfigure network resources within telecommunication networks. The method may include: receiving, with a processing system including one or more electronic processors, network data associated with a telecommunications network including a plurality of network resources, the plurality of network resources including a plurality of distributed units (DUs); determining, with the processing system, based on the network data, that a first DU included in the plurality of DUs has a traffic demand that indicates the first DU is overloaded; accessing, with the processing system, a mapping for the telecommunications network, wherein the mapping indicates a plurality of characteristics associated with each of the plurality of network resources; determining, with the one or more electronic processors, using the mapping, a plurality of resource availability statuses, wherein each of the plurality of resource availability statuses is associated with one of the plurality of network resources; selecting, with the processing system, a second DU included in the plurality of DUs based on a resource availability status for the second DU, wherein the resource availability status of the second DU indicates that the second DU has available resources to process a portion of the traffic demand of the first DU; reconfiguring, with the processing system, the second DU such that the second DU is configured to process the portion of the traffic demand of the first DU; and controlling, with the processing system, routing of the portion of the traffic demand of the first DU such that the second DU processes the portion of the traffic demand of the first DU.

According to another aspect of the present disclosure, a non-transitory computer-readable medium is provided. The non-transitory computer-readable medium stores instructions that, when executed by one or more electronic processors of a processing system in a telecommunications network, cause the processing system to perform operations comprising: receiving, at a first distributed unit (DU) of the telecommunications network, network traffic from a user equipment (UE) coupled to the telecommunications network; controlling handling of the network traffic with the first DU, executing a set of DU network functions, and a centralized unit (CU), executing a set of CU network functions, of the telecommunications network; receiving, at the first DU, subsequent network traffic; detecting a network condition at the first DU, wherein the network condition is a result of receiving the subsequent network traffic at the first DU; responsive to detecting the network condition, dynamically reconfiguring the first DU of the telecommunications network; and controlling handling of the subsequent network traffic using the dynamically reconfigured first DU of the telecommunications network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 illustrates a table representing an example resource mapping in accordance with various aspects of the present disclosure.

FIG. 5 is a flowchart of an example method to dynamically reconfigure network resources within telecommunication networks in accordance with various aspects of the present disclosure.

FIG. 6 illustrates an example telecommunications network prior to a transformation or reconfiguration of network resources for the telecommunications network in accordance with some configurations.

FIG. 7 illustrates another example telecommunications network prior to a transformation or reconfiguration of network resources for the telecommunications network in accordance with some configurations.

FIG. 8 illustrates another example telecommunications network prior to a transformation or reconfiguration of network resources for the telecommunications network in accordance with some configurations.

FIG. 9 illustrates an example telecommunications network after transformation or reconfiguration of network resources for the telecommunications network in accordance with some configurations.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (UE) (e.g., mobile phones and the like). As another example, the wireless communication networks described herein may comply with other industry standards, such as, e.g., the Distributed Radio Access Network (Distributed RAN or D-RAN) or the like. In some configurations, the wireless communication network may be another type of wireless network, such as, for example, a sixth generation (6G), wireless network.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Although spectral efficiency of 5G is better than 4G, higher bit-rates supported by 5G increases the network energy consumption in 5G. To increase energy efficiency, the offered network capacity should fit the traffic. For instance, when a network provider has active UE's fewer than a threshold in a cell (low traffic), the active UE(s) may be transferred to a roaming partner network and the cell (or network resources thereof) pursuant to a roaming mode. According, the technology disclosed herein implements a roaming model to increase network energy efficiency.

Accordingly, the technology disclosed herein provides methods and systems to dynamically reconfigure network resources within telecommunication networks. As described herein, the network resources may be dynamically reconfigured (or tuned) such that network resources are efficiently utilized to accommodate dynamic network traffic demands. For instance, the technology disclosed herein provides a technical solution to the technical problem of configuring higher midhaul and backhaul transport bandwidth by optimizing existing network resources such that those existing network resources may be utilized more efficiently. By optimizing how existing network resources are utilized, existing network resources may cater to dynamic user demand and spectrum usage. In some examples, the technology disclosed herein may provide or otherwise enable dynamic and efficient transport and radio digital unit transformation, parameter retuning in an O-RAN for optimized performance and radio network resource usage. The technology disclosed herein may provide or otherwise implement dynamic IP transport tuning with a hybrid approach to network functions connecting to multiple locations based on transport congestion or user traffic demands.

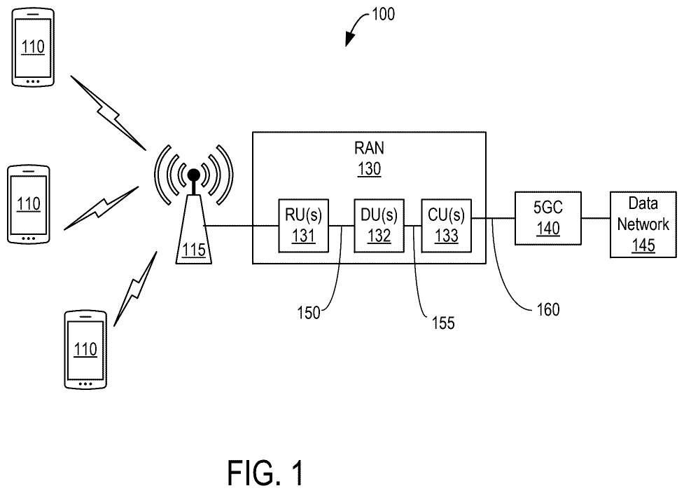

FIG. 1 illustrates an example of a telecommunications network 100 in accordance with various aspects of the present disclosure. In the telecommunications network 100 of FIG. 1, one or more user equipment (UE) 110 may be connected to a wireless access point 115, which in turn may be connected to a radio access network (RAN) 130, including, e.g., one or more radio units (RUs) 131, distributed units (DUs) 132, centralized units (CUs) 133, or a combination thereof. In some configurations, the RAN 130 may be implemented as a virtualized RAN 130. As noted herein, the O-RAN model follows a virtualized model for a 5G wireless architecture in which 5G base stations (e.g., gNBs) are implemented using separate CUs, DUs, and RUs. In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Accordingly, in some configurations, the RAN 130 may be implemented in accordance with the O-RAN model, such that the RUs 131, the DUs 132, or CUs 133 may be O-RAN RUs, CUs, or DUs. The RAN 130 may provide a connection to a 5G core network (5GC) 140, which in turn may provide a connection to a data network 145. The data network 145 may be the Internet, an enterprise data network, combinations thereof, or the like. The wireless access point 115 and the RAN 130 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof. In some configurations, the telecommunication network 100 may be implemented pursuant to the O-RAN model, as described herein.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), or any computerized device capable of communicating via a cellular network. More generally, the UEs 110 can represent any type of device that has an incorporated 5G interface, such as, e.g., a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connect. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131. The RU(s) 131 are configured to convert radio signals sent to and received from the antenna(s) into a digital signal. The wireless access point 115 is connected to the RAN components 130 via a fronthaul link (represented in FIG. 1 by reference numeral 150) over which the digital signals may be communicated. The DU(s) 132 may be connected to the CU(s) 133 via a midhaul link (represented in FIG. 1 by reference numeral 155). The CU(s) 133 may be connected to the 5GC 135 via a backhaul link (represented in FIG. 1 by reference numeral 160). While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

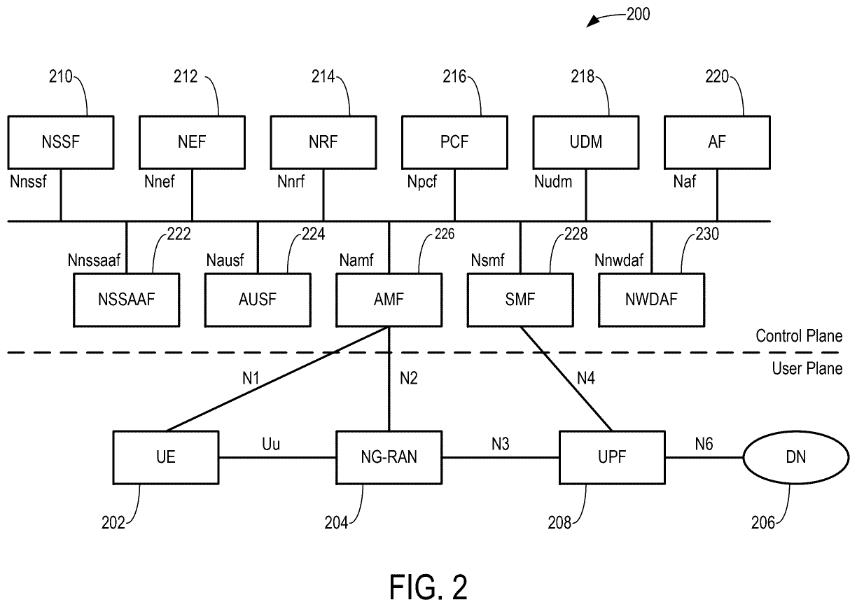

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For ease of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NF as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from corresponding cell site(s).

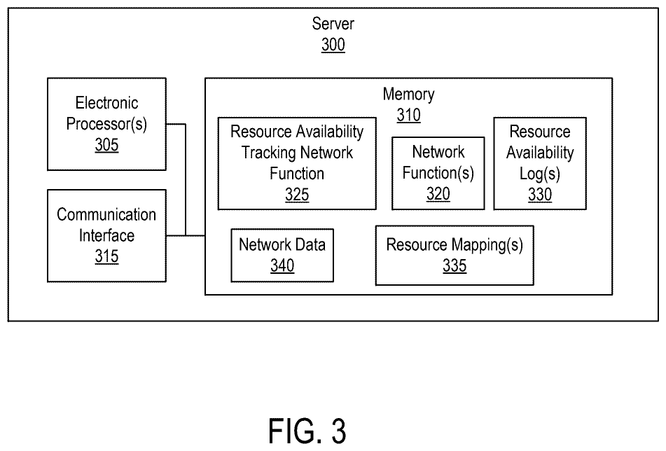

For example, FIG. 3 schematically illustrates an example server 300 (e.g., a data center server for the 5GC 140 of FIG. 1) according to some configurations. As illustrated in FIG. 3, the server 300 includes an electronic processor 305, a memory 310, and a communication interface 315. The electronic processor 305, the memory 310, and the communication interface 315 may communicate wirelessly, over one or more communication lines or buses, or a combination thereof. The server 300 may include additional, different, or fewer components than those illustrated in FIG. 3 in various configurations. The server 300 may perform additional or different functionality than the functionality described herein. Also, the functionality (or a portion thereof) described herein as being performed by the server 300 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 315 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The electronic processor 305 includes one or more electronic processors (e.g., one or more microprocessors, one or more application-specific integrated circuits (ASICs), and/or one or more other suitable electronic device for processing data), and the memory 310 includes a non-transitory, computer-readable storage medium. The electronic processor 305 is configured to retrieve instructions and data from the memory 310 and execute the instructions.

For example, as illustrated in FIG. 3, the memory 310 may store one or more network functions 320 (also referred to herein as the NFs 320). The NFs 320 may include, e.g., one or more of the network functions described herein, such as, e.g., with respect to FIG. 2.

In some configurations, the memory 310 may store a resource availability tracking network function 325 (also referred to herein as the RAT-NF 325) and one or more resource availability logs 330. In some examples, the resource RAT-NF 325 may be included as one of the NFs 320. In some configurations, the RAT-NF 325 may be a virtualized NF (or software application) executable by the electronic processor 305. The RAT-NF 325 (when executed by the electronic processor 305) may perform functionality (or portion(s) thereof) associated with the systems and methods described herein.

For instance, in some configurations, the RAT-NF 325 may be a NF that tracks resource availability for one or more network resources included in the telecommunications network 100. As used herein, resource availability may represent whether a given network resource is underutilized such that, e.g., the network resource has resources that are not being utilized (or are available for use). For example, when the DU 132 can process a present network demand on the DU 132 using only a portion of the resources of the DU 132, the DU 132 may be underutilized or have available resources (e.g., where the available resources may be the remaining portion of the resources of the DU 132 that are not being used to process the present network demand on the DU 132). Accordingly, in some configurations, the RAT-NF 325 (when executed by the electronic processor 305) may determine resource availability with respect to the telecommunications network 100, including, e.g., resource availability with respect to one or more of the network resources included in the telecommunications network 100 (e.g., the RUs 131, the DUs 131, the CUs 133, etc.).

In some configurations, the RAT-NF 325 may track the resource availability using the resource availability log 330. The resource availability log 330 may include one or more resource availability statuses associated with the telecommunications network 100 (or network resources included therein). For instance, the resource availability log 330 may associate each of the network resources of the telecommunications network 100 with a resource availability status. As one example, the resource availability log 330 may include a resource availability status for one or more of the DUs 131 included in the telecommunications network 100. Accordingly, the resource availability status may indicate (or otherwise represent) whether a corresponding network resource has available resources (e.g., un-used resources). As one example, when the network resource has resources available, the resource availability status for the network resource may be an “underutilized” status or a “resource available” status. As another example, when the network resource does not have resources available (e.g., is presently utilizing or will be utilizing all of its resources), the resource availability status for the network resource may be a “resource unavailable” status.

In some examples, the resource availability status may indicate a minimum amount of resources that may be utilized to process a network demand at a network function, a maximum amount of resources available that may be available to process an additional network demand at the network resource, or a combination thereof. For example, the minimum amount of resources may indicate an amount of resources that the DU 132 will utilize when processing the network demand of the DU 132, and the maximum amount of resources may indicate an amount of resources that the DU 132 has available to process an additional network demand (e.g., a portion of network traffic associated with or at another network resource, such as, e.g., a second DU, a third DU, etc.). Accordingly, in some configurations, the RAT-NF 325 may determine, for one or more network resources of the telecommunications network 100, a minimum amount of resources that may be utilized to process a network demand at a network function, a maximum amount of resources available that may be available to process an additional network demand at the network resource, or a combination thereof.

Alternatively, or in addition, in some configurations, the resource availability status may indicate whether a network resource is compatible with an additional network demand (or additional network traffic) from another network resource. A network resource may be compatible with network traffic (e.g., additional network traffic from another network resource) when the network resource is configured (including, e.g., could be configured or configurable) to process the network traffic. For example, whether a network resource is compatible with additional network traffic from another network resource may be based on whether the network resource has the capability (whether presently configured to or could be reconfigured to) to process (or otherwise handle) the additional network traffic.

In some instances, whether a network resource is compatible (or capable) of processing additional network traffic may be based on one or more characteristics or parameters of the network resource (also referred to herein as “resource characteristics”). As network resources may be implemented using a variety of hardware or software variants, as used herein, a resource characteristic of a network resource may generally refer to resource characteristic(s) of a particular instance of that type of network resource (e.g., a particular hardware or software variant of that network resource). For example, a first DU may be implemented via a server having a first hardware or software variant while a second DU may be implemented via another server having a second, different hardware or software variant.

A resource characteristic may include (or otherwise relate to): e.g., a number of cells, sectors, or regions that the network resource can support (e.g., 12 to 18 cells, 15 cells, 3 to 6 sectors, etc.); a maximum number of users (or UEs 110) that the network can support (e.g., 384, 538, 1152, etc.); a frequency range that the network resource can support (e.g., Frequency Range 1 (FR1), including, e.g., sub-6 GHz frequency bands or 410 MHz to 7125 Mhz; Frequency Range 2 (FR2), including, e.g., frequencies within the mmWave region (above 6 Hz); etc.); whether the network resource supports frequency-division duplexing (FDD); whether the network resource supports time-division duplexing (TDD); a maximum number of customer-premises equipment (CPE) that the network resource can support; a maximum channel bandwidth that the network resource can support (e.g., 200 MHz to 300 MHz); a throughput that the network resource can support (e.g., 1.2 Gbps to 3 Gbps, up to 12 Gpbs, etc.); a maximum number of RUs that the network resource can support (e.g., 12 to 18 RUs); etc.

As illustrated in FIG. 3, in some instances, the memory 310 may store a resource mapping 335. The resource mapping 335 may be a mapping for the telecommunications network 100 (including, e.g., the network resources included therein). In some configurations, the resource mapping 335 may map (or otherwise associate) each network resource included in the telecommunications network 100 with one or more resource characteristics of that network resource. As one example, the resource mapping 335 may map a first DU 132 to a first set of resource characteristics and map a second DU 132 to a second set of resource characteristics. In some instances, the resource mapping 335 may be a table (e.g., a look up table) identifying various hardware or software variants for the network resource(s) of the telecommunications network 100 (e.g., hardware or software variants for particular network resource instances).

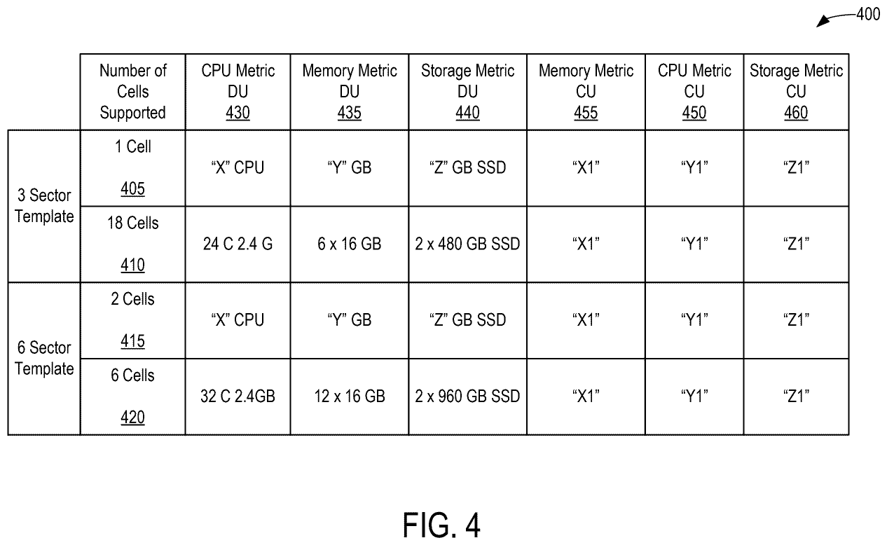

For example, FIG. 4 illustrates a table 400 representing an example of the resource mapping 335 in accordance with some configurations. As illustrated in FIG. 4, the table 400 includes resource characteristics for various hardware or software variants of the DU 132, including a first DU variant 405, a second DU variant 410, a third DU variant 415, and a fourth DU variant 420. As illustrated in FIG. 4, the first DU variant 405 and the second DU variant 410 may support three sectors while the third DU variant 415 and the fourth DU variant 420 may support six sectors. The first DU variant 405 may support 1 cell in each of the 3 sectors, the second DU variant 410 may support 18 cells in each of the 3 sectors, the third DU variant 415 may support 2 cells in each of the 6 sectors, and the fourth DU variant 420 may support 6 cells in each of the 6 sectors. As also illustrated in FIG. 4, the resource mapping 335 may include a CPU metric 430, a memory metric 435, and a storage metric 440 for each of the DU variants. In some instances, as illustrated in FIG. 4, the resource mapping 335 may include a CU CPU metric 450, a CU memory metric 455, and a CU storage metric 460.

As one example, when “Y1” is a single vCPU for CU-CP function, then it is capable of supporting 50 cells across one or more DUs 132. As another example, when “Y1” is a single vCPU, then it is capable of supporting 24 cells for Cu-CP and CU-UP functions across one or more DUs 132. As yet another example, when “X1” is 10 GB memory, it can support up to 50 cells across one or more DUs 132. As yet another example, when “Z1” is 18 GB elastic file system storage, it can support up to 50 cells.

As such, while a network resource may have resources available to process additional network traffic, the network resource may not be configurable (or otherwise capable) of processing the additional network demand. As one example, a first DU may be configured (or configurable) to support a first frequency range (e.g., FR1, 3GPP FDD+TDD) and a second DU may be configured (or configurable) to support a second frequency range (e.g., FR2, mmWave). Following this example, when the first DU is overloaded (e.g., experiencing a high traffic demand) and the second DU has available resources, the second DU may not be capable (or otherwise configurable) to process (or otherwise handle) network traffic at the first frequency range. In this example, while the second DU has available resources, the second DU cannot process the network traffic at the first DU, and, as such, the second DU may have an “unavailable” status (as a resource availability status). Accordingly, as described in greater detail herein, in some configurations, the RAT-NF 325 may determine the resource availability status using the resource mapping 335 and one or more characteristics or parameters of the additional network demand (e.g., the network traffic (or portion thereof) at the overloaded network resource).

In some configurations, the RAT-NF 325 may update or otherwise maintain the resource availability log 330 such that the resource availability log 330 remains updated or otherwise reflects the present resource availability statuses for the network resources included in the telecommunications network 100. Accordingly, in some configurations, the RAT-NF 325 may track resource availability in real time (or near real-time) such that a resource availability for a network resource is readily available or accessible at any given time. For instance, in some configurations, the RAT-NF 325 may update the resource availability log 330 in real-time (or near real-time). Alternatively, or in addition, in some instances, the RAT-NF 325 may track resource availability periodically or intermittently. For instance, the RAT-NF 325 may track resource availability (or otherwise determine resource availability status(es)) in response to detecting a trigger, such as, e.g., a change or modification to the telecommunications network 100 (or network function(s) therein), an overloaded network resource, etc.

Returning to FIG. 3, in some configurations, the memory 310 may store network data 340. The network data 340 may include information or data relating to the telecommunications network 100, including one or more network resources thereof (e.g., the RUs 131, the DUs 132, the CUs 133, etc.). In some examples, the network data 340 may include or otherwise indicate a network demand (or an amount of network traffic) at a particular network resource. As one example, the network data 340 may indicate a network demand (or traffic demand) at the DU 132. In some instances, the network data 340 may indicate a present network demand at the DU 132. Alternatively, or in addition, the network data 340 may indicate a previous network demand or a predicted network demand at the DU 132. In some configurations, the network data 340 may indicate whether the network demand at a network resource is overloading the network resource. A network demand may overload a network resource when a demand on the network resource is more than that network resource can handle or process. In some instances, whether a network resource is overloaded may be determined based on whether a present network demand on the network resource exceeds an overload threhsold or satisfies an overload condition.

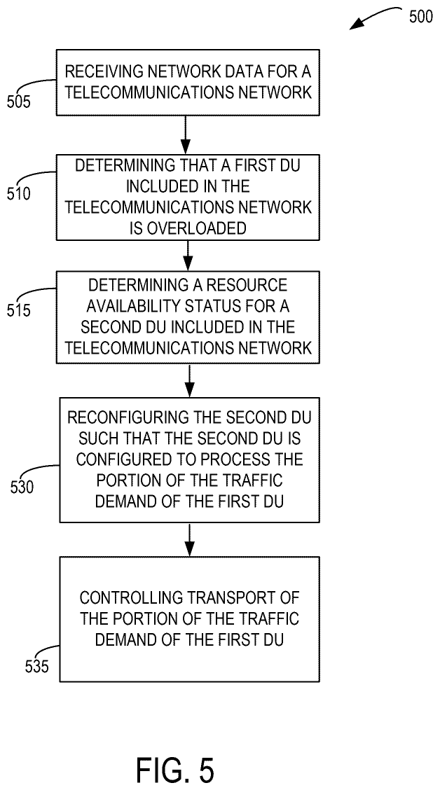

FIG. 5 is a flowchart illustrating an example method 500 to dynamically reconfigure network resources within telecommunications networks (e.g., the telecommunications network 100) in accordance with some configurations. The method 500 is described as being performed by the server 300 and, in particular, the RAT-NF 325 when executed electronic processor 305. However, as noted above, the functionality (or a portion thereof) described with respect to the method 500 may be performed by other devices, such as, e.g., another server or device within the telecommunications network 100, or distributed among a plurality of devices, such as a plurality of servers included in a cloud service. Thus, although described as begin performed by the server 300, the method 500 may also be described as being performed by a processing system including one or more electronic processors (e.g., another processor or processors of the telecommunication network 100).

As illustrated in FIG. 5, the server 300 may receive (or otherwise access) network data (e.g., the network data 340) for the telecommunications network 100 (at block 505). In some configurations, one or more network resources of the telecommunications network 100 may provide the network data 340 to the server 300. Alternatively, or in addition, the server 300 may request or otherwise retrieve the network data 340 from one or more network resources of the telecommunications network 100 (e.g., the DU(s) 132). The server 300 may access the network data 340 from the memory 310. Alternatively, or in addition, the server 300 may access the network data 340 from a remote device (e.g., one or more components of the telecommunications network 100 that the network data 340 originates from, another remote database or storage device, etc.).

The server 300 may determine, based on the network data 340, that a first DU (e.g., the DU 132) included in the telecommunications network 100 is overloaded (at block 510). For instance, the server 300 may determine that the first DU is experiencing a traffic demand (or network demand) that is overloading the first DU, based on, e.g., resources of the first DU. In some instances, the first DU that is overloaded may also be referred to herein as the overloaded DU. In some instances, the server 300 may detect that the first DU is overloaded by determining, from the network data 340, a present traffic demand at the first DU and determine whether that present traffic demand exceeds a threshold or otherwise satisfies an overload condition.

In some configurations, the server 300 may determine a resource availability status for a second DU included in the telecommunications network 100 (at block 515). As described in greater detail herein, a resource availability status may indicate (or otherwise represent) whether a corresponding network resource has available resources (e.g., un-used resources). In some instances, the server 300 may determine the resource availability status for the second DU by accessing (or otherwise requesting) the resource availability status for the second DU from the resource availability log 330. As one example, the server 300 may determine the resource availability status for the second DU by executing a look up function with respect to the resource availability log 330. Alternatively, or in addition, in some configurations, the server 300 may determine the resource availability status for the second DU responsive to detecting (or otherwise determining) that the first DU is overloaded. For instance, the server 300 may determine the resource availability status for the second DU (in real-time or near real-time) subsequent to determining that the first DU is overloaded responsive to the first DU is overloaded.

As described herein, in some configurations, the server 300 may determine the resource availability status for the second DU using the resource mapping 335. Accordingly, in some configurations, the server 300 may access the resource mapping 335, e.g., from the memory 310. As described herein, the resource mapping 335 may be a mapping for the telecommunications network 100 (including, e.g., the network resources included therein). In some configurations, the resource mapping 335 may map (or otherwise associate) each network resource included in the telecommunications network 100 with one or more resource characteristics of that network resource. Accordingly, in some instances, the server 300 may use (or otherwise access) the resource mapping 335 to determine a set of resource characteristics for the second DU. As described herein, the resource characteristics of a network resource, such as, e.g., the second DU, may indicate or otherwise represent capabilities of the network resource. As such, in some instances, the server 300 may determine one or more capabilities of the second DU based on the resource mapping 335 (e.g., one or more characteristics of the second DU).

In some configurations, the server 300 may determine the resource availability status for the second DU based on the network data 340 and the resource mapping 335. For example, the network data 340 may indicate a present network demand (or traffic demand) at the second DU and the resource mapping 335 (e.g., one or more resource characteristics of the second DU) may indicate one or more capabilities of the second DU, including, e.g., a total amount of resources of the second DU. Using this information, the server 300 may determine whether the second DU has resources available such that the second DU could process a portion of the traffic demand of the first DU. In some instances, using this information, the server 300 may determine a minimum amount of resources that may be utilized to process a network demand at a network function, a maximum amount of resources available that may be available to process an additional network demand at the network resource, or a combination thereof.

Alternatively, or in addition, the server 300 may determine, based on the resource mapping 335, whether the second DU is capable of processing the portion of the traffic demand of the first DU (e.g., whether the second DU is compatible with the portion of the traffic demand of the first DU). For instance, as noted herein, while a network resource (e.g., the second DU) may have resources available to process additional network traffic (e.g., the portion of the traffic demand of the first DU), the network resource (e.g., the second DU) may not be configurable (or otherwise capable) of processing the additional network demand (e.g., the portion of the traffic demand of the first DU). Accordingly, in some configurations, the RAT-NF 325 may determine the resource availability status based on whether the second DU is compatible with (or configurable to be compatible with) the portion of the traffic demand of the first DU.

Accordingly, in some configurations, the server 300 may determine one or more characteristics of the portion of the traffic demand of the first DU, such as, e.g., one or more constraints or parameters of the portion of the traffic demand of the first DU. As one example, the server 300 may determine a latency constraint or metric for the portion of the traffic demand (e.g., how much latency is tolerated or allowed for the portion of the traffic demand, based on, e.g., a service agreement related to the portion of the traffic demand). As another example, the server 300 may determine that the portion of the traffic demand is a live video stream, and, thus, may be associated with a particular channel bandwidth. The server 300 may determine the resource availability status for the second DU based on the characteristic(s) of the portion of the traffic demand of the first DU and the resource mapping 335 (e.g., the resource characteristic(s) of the second DU). For instance, the server 300 may determine, based on the resource characteristic(s) of the second DU, whether the second DU can process network traffic having the characteristic(s) of the portion of the traffic demand. As one example, when the portion of the traffic demand is associated with a particular latency constraint, the server 300 may determine the resource availability status for the second DU based on whether the resource characteristic(s) of the second DU indicate that the second DU can process network traffic in compliance with that latency constraint. Accordingly, in some examples, the server 300 may determine the resource availability status for the second DU based on midhaul or backhaul congestion. As another example, when the portion of the traffic demand is associated with a particular channel bandwidth, the server 300 may determine the resource availability status for the second DU based on whether the resource characteristic(s) of the second DU indicate that the second DU can process network traffic at that particular channel bandwidth.

In some instances, the server 300 may determine the availability resource status of the second DU based on historical traffic or network demand on the second DU. For instance, the server 300 may access historical (or previous) network data associated with the second DU and determine (or otherwise predict) whether the second DU will have resources available based on previous network demand trends or patterns.

In some instances, the server 300 may determine a resource availability status for each network resource included in the telecommunications network 100. For example, the server 300 may determine a first resource availability status for a first network resource (e.g., the second DU) and a second resource availability status for a second network resource (e.g., a third DU). In such instances, the server 300 may select (or otherwise identify) the second DU based on a resource availability status for the second DU, in comparison to other resource availability statuses for other network resources. For example, the server 300 may select the second DU from a plurality of DUs when the second DU has a resource availability status indicating that the second DU has available resources to process a portion of the traffic demand at the first DU.

In some configurations, the server 300 may monitor (in real-time or near real-time) resource availability for each network resource of the telecommunications network 100. In such configurations, the server 300 may maintain (or update) the resource availability log 330 to represent a present resource availability (a present resource availability status) for each of the network resources of the telecommunications network 100. In some instances, the server 300 may transmit (or otherwise distribute) a copy of the resource availability log 330 to one or more network resources of the telecommunications network 100, such that, the one or more network resources included in the telecommunications network 100 may be informed (locally) with respect to resource availability of other network resources in the telecommunications network 100. The server 300 may transmit (or distribute) the copy of the resource availability log 330 responsive to an update, based on a distribution schedule, etc.

When the resource availability status of the second DU indicates that the second DU has resources available to process the portion of the traffic demand of the first DU, the server 300 may reconfigure the second DU such that the second DU is configured to process the potion of the traffic demand of the first DU (at block 530). In some configurations, the server 300 may reconfigure the second DU by dividing the second DU into a plurality of smaller DUs (e.g., a plurality of resource segments). In some instances, a first resource segment may function as a DU for processing an existing network traffic at the second DU while a second resource segment may function as a combination of a DU and a corresponding CU (referred to herein as a combined DU-CU) for processing the portion of the traffic demand of the first DU.

The server 300 may control routing (or transport) of the portion of the traffic demand of the first DU such that the second DU processes the portion of the traffic demand of the first DU. In some examples, the server 300 may control the transport of the portion of the traffic demand to the second DU via a cell site router (CSR) that couples a radio unit (RU) of the telecommunications network 100 to the first DU and the second DU. Alternatively, or in addition, in some instances the server 300 may control routing of the portion of the traffic demand of the first DU by establishing a communication connection (e.g., a direct connection or link) between the first DU and the second DU. In instances where the second DU is divided into resource segments, the server 300 may establish a communication connection between the first DU and the DU included in the combined DU-CU.

In some configurations, the server 300 may select (or otherwise identify) a plurality of additional DUs to support the overloaded DU (e.g., the first DU), such that each of the additional DUs process a portion of the traffic demand of the first DU. For instance, the server 300 may select the second DU and a third DU, where the respective resource availability statuses for the second DU and the third DU indicate that the second DU and the third DU have resources available (and are capable) of processing portions of the traffic demand of the first DU. The server 300 may reconfigure the second DU or the third DU such that the second DU or the third DU are configured to process respective portions of the traffic demand of the first DU. For instance, the second DU may process a first portion of the traffic demand of the first DU and the third DU may process a second portion of the traffic demand of the first DU. In some instances, the second DU and the third DU process the respective portions of the traffic demand of the first DU in parallel (e.g., at the same time).

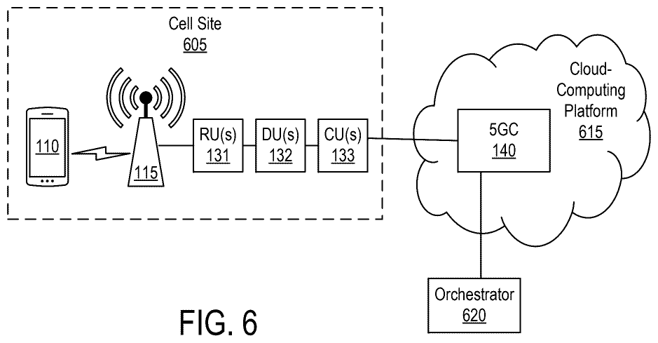

FIG. 6 illustrates an example arrangement (or type) of the telecommunications network 100 prior to a transformation or reconfiguration of network resources for the telecommunications network 100 in accordance with some configurations. As illustrated in the example of FIG. 6, the telecommunications network 100 includes a cell site 605. The cell site 605 includes the UE 110, the wireless access point 115, the RU 131, the DU 132, and the CU 133. In the illustrated example, the CU 133 may communicate with the 5GC 140, which may be implemented using a cloud-computing platform or service 615, as described herein. As also illustrated in FIG. 6, in some configurations, the 5GC 140 may be coupled to an orchestrator 620. The orchestrator 620 may be a logical functional module. The orchestrator 620 may be configured to control or otherwise facilitate deployment, scaling, or mapping NFs deployed across multiple L2/L3 switches and routers including, e.g., CSR (as virtual/logical network mapper of functional stitches) of RAN infrastructure (e.g., ORAN CU, ORAN DU, ORAN RU, etc.) to deliver an automated provisioning & deployment solution. The orchestrator 620 may have insight of the operational and current state of a site involving ORAN Infrastructure including, e.g., an Element Management System (EMS). The orchestrator 620 may utilize the resource availability state of the ORAN nodes to decide to scale up/down, resource share across multiple NF supporting the transformation decision of NF to include multiple NF on a demand basis.

With respect to FIG. 6, the ORAN CU resource may be transformed as ORAN DU resource to support adding cell site support need in that specific site. In some configurations, the orchestrator 620 may support mapping to either ORAN CU in the cloud-computing platform 615 or from a different ORAN CU connected through a cell site router (CSR) to cater the specific specifications of the telecommunications network 100, as described herein.

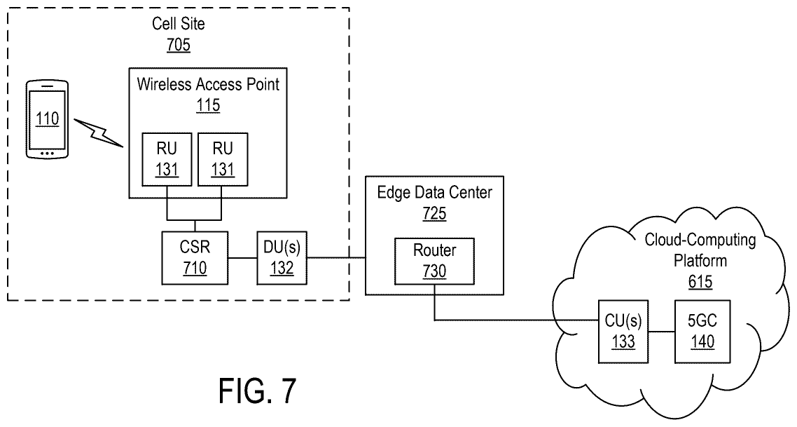

FIG. 7 illustrates another example arrangement (or type) of the telecommunications network 100 prior to a transformation or reconfiguration of network resources for the telecommunications network 100 in accordance with some configurations. As illustrated in the example of FIG. 7, the telecommunications network 100 includes a cell site 705. The cell site 705 includes the UE 110, the wireless access point 115, the RUs 131, a cell site router (CSR) 710, and the DU 132. In some configurations, the CSR 710 may function as a gateway between the cell site 705 (e.g., the wireless access point 115) and a core network (e.g., the 5GC 140). In some configurations, the CSR(s) 710 may aggregate mobile data traffic from a cellular access network (e.g., mobile data traffic received at the wireless access point 115 via the RUs 131 from the UE(s) 110) and transmits (or otherwise provides) the aggregated mobile data traffic to a service provider's core network (e.g., the 5GC 140). For example, as illustrated in FIG. 7, in some configurations, the RUs 131 and the DU 132 may communicate via the CSR 710. In the example of FIG. 7, the DU 132 may communication with an edge data center 725. The edge data center 725 may communication with the DU 132 and the CU 133. The CU 133 may communicate with the 5GC 140. In the illustrated example, the CU 133 and the 5GC 140 may be implemented using the cloud-computing platform or service 615, as described herein.

With respect to FIG. 7, the ORAN CU may be implemented in the cloud-computing platform 615, which may allow for increased scale in/out options while the ORAN DU and the ORAN CU in FIG. 6 can share the local ORAN CU resource with either the same site or another second, third site DU in case the second and the third DU of different site is in need of additional ORAN CU Resources, and can be shared through the connecting CSR (e.g., the CSR 710) falling within the latency limits to support the requisite service.

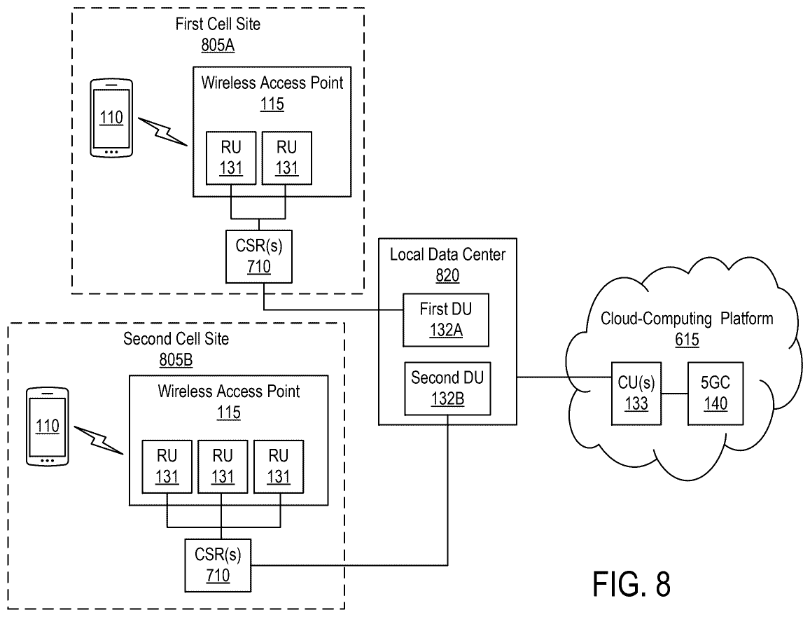

FIG. 8 illustrates an example arrangement (or type) of the telecommunications network 100 prior to a transformation or reconfiguration of network resources for the telecommunications network 100 in accordance with some configurations. In the example of FIG. 8, the telecommunications network 100 includes a first cell site 805A that includes a UE 110, a wireless access point 115, having two RUs 131, and a CSR 710 and a second cell site 805B that includes a UE 110, a wireless access point 115, having three RUs 131, and a CSR 710. As illustrated in FIG. 8, each cell site 805A, 805B may communicate with the cloud-computing platform 615 (e.g., the CUs 133 and the 5GC 140) via a local data center 820. For instance, the local data center 820 may include a first DU 132A configured to handle (or process) network traffic for the first cell site 805A. The local data center 820 may include a second DU 132B configured to handle (or process) network traffic for the second cell site 805B. As illustrated in FIG. 8, a cluster of DUs (e.g., the first DU 132A and the second DU 132B) may be grouped (or clustered) at the local data center 820), such that the cluster of DUs may serve multiple cell site ORAN RUs across a geographical wireless service area. For example, with reference to FIG. 8, the first DU 132A may serve the RUs 131 of the first cell site 805A and the second DU 132B may serve the RUs 131 of the second cell site 805B.

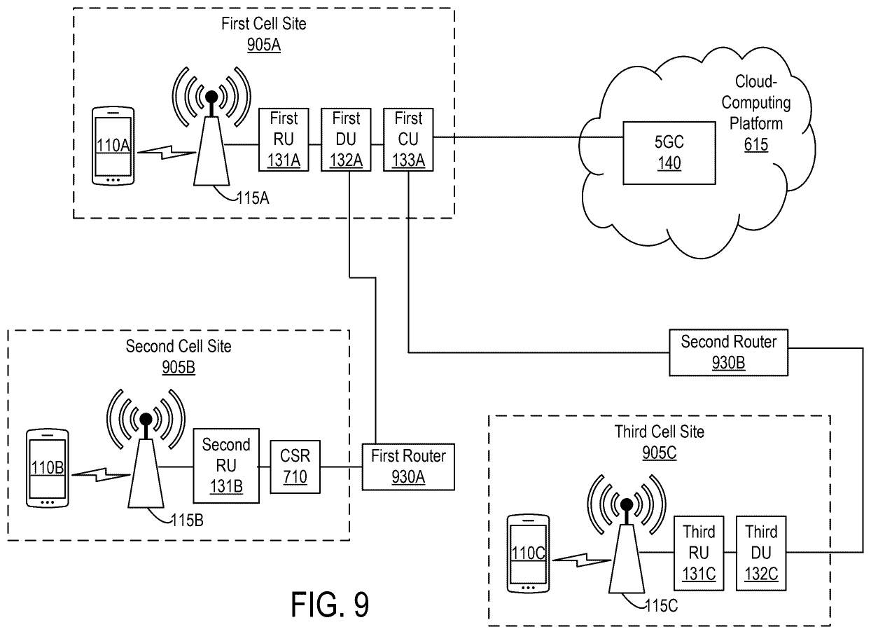

FIG. 9 illustrates an example arrangement (or type) of the telecommunications network 100 after transformation or reconfiguration of network resources for the telecommunications network 100 in accordance with some configurations. In the example of FIG. 9, network resources of the telecommunications network 100 may be reconfigured (or transformed), such as, e.g., as a result of performance of one or more of the blocks illustrated in FIG. 5.

For instance, as illustrated in FIG. 9, the telecommunications network 100 may include a first cell site 905A, a second cell site 905B, and a third cell site 905C. The first cell site 905A may include a first UE 110A, a first wireless access point 115A, a first RU 131A, a first DU 132A, and a first CU 133A. The second cell site 905B may include a second UE 110B, a second wireless access point 115B, a second RU 131B, and the CSR 710. The third cell site 905C may include a third UE 110C, a third wireless access point 115C, a third RU 131C, and a third DU 132C. As illustrated in FIG. 9, the telecommunications network 100 may include a first router 930A and a second router 132B. The first router 132A may couple the CSR 710 of the second cell site 905B to the first DU 132A of the first cell site 905A. The second router 132B may couple the third DU 132C of the third cell site 905C to the first CU 133A of the first cell site 905A.

With respect to FIG. 9, any cell site CU can serve ORAN DUs of the same cell site as well as the other cell sites through a CSR (e.g., the CSR 710) or another router (e.g., the first router 930A or the second router 930B). For example, as illustrated in FIG. 9, the first CU 133A of the first cell site 905A may serve the first DU 132A of the first cell site 905A as well as the third DU 132C of the third cell site 905C (via the second router 930B). Alternatively, or in addition, in some configurations, an ORAN DU of a cell site can serve different cell site ORAN RUs. For example, as illustrated in FIG. 9, the first DU 132A of the first cell site 905A may also serve the second RU 131B of the second cell site 905B.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to dynamically reconfigure network resources within telecommunication networks, the system comprising:
a processing system including one or more electronic processors configured to:
maintain a mapping for a telecommunications network, wherein the mapping indicates a plurality of characteristics associated with each of a plurality of network resources included in the telecommunications network, the plurality of network resources including a first distributed unit (DU) and a second DU;
detect, based on network traffic data for a telecommunications network, that the first DU included in the telecommunications network has a traffic demand that exceeds a threshold;
determine, using the mapping, a resource availability status for the second DU included in the telecommunications network; and
when the resource availability status for the second DU indicates that the second DU has available resources to process a portion of the traffic demand of the first DU:
reconfigure the second DU such that the second DU is configured to process the portion of the traffic demand of the first DU; and
control transport of the portion of the traffic demand of the first DU such that the second DU processes the portion of the traffic demand.

2. The system of claim 1, wherein the first DU is included in an open radio access network (ORAN) of the telecommunications network.

3. The system of claim 1, wherein the plurality of characteristics includes, for each of the plurality of network resources, at least one of: a maximum number of cells, a maximum number of users, a frequency range, a maximum number of customer-premises equipment, a throughput, or a maximum channel bandwidth.

4. The system of claim 1, wherein the processing system is configured to:
determine a characteristic of the portion of the traffic demand of the first DU; and
determine, based on the characteristic of the portion of the traffic demand of the first DU and the mapping, the resource availability status for the second DU;
wherein the resource availability status indicates that (1) the second DU has resources available to process the portion of the traffic demand of the first DU and (2) the second DU is capable of processing the portion of the traffic demand of the first DU in accordance with the characteristic of the portion of the traffic demand of the first DU.

5. The system of claim 1, wherein the processing system is configured to:
control the transport of the portion of the traffic demand to the second DU via a cell site router (CSR) that couples a radio unit (RU) of the telecommunications network to the first DU and the second DU.

6. The system of claim 1, wherein the processing system is configured to reconfigure the second DU by:
dividing the second DU into a plurality of resource segments, wherein the plurality of resource segments includes:
a first resource segment configured to function as a third DU and to process an existing traffic demand of the second DU; and
a second resource segment configured to function as a fourth DU and a corresponding centralized unit (CU) and to process the portion of the traffic demand of the first DU.

7. The system of claim 6, wherein the processing system is configured to:
establish a communication connection between the first DU and the fourth DU.

8. The system of claim 1, wherein the processing system is configured to:
determine a plurality of resource availability statuses, wherein each resource availability status of the plurality of resource availability statuses is associated with a network resource included in the plurality of network resources of the telecommunications network, wherein the resource availability status for the second DU is included in the plurality of resource availability statuses; and
select, from the plurality of network resources, the second DU based on the resource availability status for the second DU.

9. The system of claim 1, wherein the processing system is configured to:
monitor resource availability for each of the plurality of network resources of the telecommunications network;
maintain a log representing a present resource availability for each of the plurality of network resources of the telecommunications network; and
distribute a copy of the log to at least one of the plurality of network resources of the telecommunications network.

10. A method to dynamically reconfigure network resources within telecommunication networks, comprising:
receiving, with a processing system including one or more electronic processors, network data associated with a telecommunications network including a plurality of network resources, the plurality of network resources including a plurality of distributed units (DUs);
determining, with the processing system, based on the network data, that a first DU included in the plurality of DUs has a traffic demand that indicates the first DU is overloaded;
accessing, with the processing system, a mapping for the telecommunications network, wherein the mapping indicates a plurality of characteristics associated with each of the plurality of network resources;
determining, with the one or more electronic processors, using the mapping, a plurality of resource availability statuses, wherein each of the plurality of resource availability statuses is associated with one of the plurality of network resources;
selecting, with the processing system, a second DU included in the plurality of DUs based on a resource availability status for the second DU, wherein the resource availability status of the second DU indicates that the second DU has available resources to process a portion of the traffic demand of the first DU;
reconfiguring, with the processing system, the second DU such that the second DU is configured to process the portion of the traffic demand of the first DU; and
controlling, with the processing system, routing of the portion of the traffic demand of the first DU such that the second DU processes the portion of the traffic demand of the first DU.

11. The method of claim 10, further comprising:
determining, with the processing system, a characteristic of the portion of the traffic demand of the first DU; and
determining, with the processing system, based on the characteristic of the portion of the traffic demand of the first DU and the mapping, the resource availability status for the second DU;
wherein the resource availability status for the second DU indicates that (1) the second DU has resources available to process the portion of the traffic demand of the first DU and (2) the second DU is capable of processing the portion of the traffic demand of the first DU in accordance with the characteristic of the portion of the traffic demand of the first DU.

12. The method of claim 10, wherein controlling, with the processing system, the routing of the portion of the traffic demand includes controlling, with the processing system, the routing of the portion of the traffic demand to the second DU via a cell site router (CSR) that couples a radio unit (RU) of the telecommunications network to the first DU and the second DU.

13. The method of claim 10, wherein reconfiguring, with the processing system, the second DU includes:
dividing, with the processing system, the second DU into a plurality of resource segments, wherein the plurality of resource segments includes:
a first resource segment configured to function as a third DU and to process an existing traffic demand of the second DU; and
a second resource segment configured to function as a fourth DU and a corresponding centralized unit (CU) and to process the portion of the traffic demand of the first DU.

14. The method of claim 10, further comprising:
selecting, with the processing system, a third DU included in the plurality of DUs based on a resource availability status for the third DU, wherein the resource availability status of the third DU indicates that the third DU has available resources to process a second portion of the traffic demand of the first DU;
reconfiguring, with the processing system, the third DU such that the third DU is configured to process the second portion of the traffic demand of the first DU; and
controlling, with the processing system, routing of the second portion of the traffic demand of the first DU such that the third DU processes the second portion of the traffic demand of the first DU;
wherein the second DU processes the portion of the traffic demand of the first DU and the third DU processes the second portion of the traffic demand of the first DU in parallel.

15. A non-transitory computer-readable medium storing instructions that, when executed by one or more electronic processors of a processing system in a telecommunications network, cause the processing system to perform operations comprising:
monitoring network traffic at a first distributed unit (DU) included in the telecommunications network;
detecting, based on the network traffic, that the network traffic at the first DU is overloading the first DU;
determining, using a mapping for network resources of the telecommunications network, a resource availability status for a second DU included in the telecommunications network;
when the resource availability status for the second DU indicates that the second DU has available resources to handle a portion of the network traffic at the first DU, reconfiguring the second DU such that the second DU is configured to process the portion of the network traffic of the first DU; and
controlling transport of the portion of the network traffic of the first DU such that the second DU processes the portion of the network traffic at the first DU.

16. The computer-readable medium of claim 15, further comprising:
generating the mapping for the telecommunications network, wherein the mapping indicates a plurality of characteristics associated with each of a plurality of network resources included in the telecommunications network, the plurality of network resources including the first DU and the second DU.

17. The computer-readable medium of claim 15, wherein determining the resource availability status of the second DU includes:
determining, based on the portion of the network traffic of the first DU and the mapping, the resource availability status for the second DU, wherein the resource availability status indicates that (1) the second DU has available resources to process the portion of the network traffic of the first DU and (2) the second DU is configurable such that the second DU is capable of processing the portion of the network traffic of the first DU.

18. The computer-readable medium of claim 15, wherein controlling transport of the portion of the network traffic of the first DU includes
routing the portion of the network traffic to the second DU via a cell site router (CSR) that couples a radio unit (RU) of the telecommunications network to the first DU and the second DU.

19. The computer-readable medium of claim 15, wherein reconfiguring the second DU includes:
dividing the second DU into a plurality of resource segments, wherein the plurality of resource segments includes:
a first resource segment configured to function as a third DU and to process existing network traffic of the second DU; and
a second resource segment configured to function as a fourth DU and a corresponding centralized unit (CU) and to process the portion of the network traffic of the first DU.

20. The computer-readable medium of claim 15, further comprising:
monitoring resource availability for each of a plurality of network resources of the telecommunications network; and
maintaining a log representing a present resource availability for each of the plurality of network resources of the telecommunications network,
wherein determining the resource availability status for the second DU includes accessing the log and determining the resource availability status to be a present resource availability for the second DU as represented in the log.
